(19) United States
(12) Patent Application Publication
(10) Pub. No.: US 2016/0306864 A1
(43) Pub. Date: Oct. 20, 2016

(54) METHOD AND SYSTEM FOR DATA SYNCHRONIZATION

(71) Applicant: Donald Leland Estes, JR., Bedford, MA (US)

(72) Inventor: Donald Leland Estes, JR., Bedford, MA (US)

(73) Assignee: Don Estes & Associates, Inc., Lexington, MA (US)

(21) Appl. No.: 15/099,560

(22) Filed: Apr. 14, 2016

Related U.S. Application Data
(60) Provisional application No. 62/147,530, filed on Apr. 14, 2015.

(51) Int. Cl. G06F 17/30; H04L 29/08

(52) U.S. Cl. CPC G06F 17/30575; H04L 67/1095; G06F 17/30371

(57) ABSTRACT

Disclosed is a software device (“Synchronizer”) incorporating functional synchronization and data level synchronization to maintain semantic equivalence between data elements of at least two data stores. The synchronizer may be configured to operate as a pure uni-directional data level synchronizer with data model remapping and business rule validation of the data or as a pure bi-directional functional synchronizer with data remapping and transaction remapping. Additionally, the Synchronizer can operate as a hybrid of data level synchronization occurring below the business logic layer of the program and of functional synchronization occurring in the business logic layer.

### CLAIM OF PRIORITY

This application claims priority to U.S. Provisional Patent Application Ser. No. 62/147,530, filed Apr. 14, 2015, the entire disclosure of which is hereby expressly incorporated by reference herein.

### FIELD OF THE INVENTION

This disclosure relates generally to data processing devices and, more particularly, to a method, a device and/or a system of data synchronization.

### BACKGROUND

During the modernization of one application system which is in daily production use, when it comes time to shift the processing from the old system of record to the new system of record, the organization is exposed to a significant amount of organization risk. In all but a few cases, the system must cease operations for a short period of time ranging from minutes to days during which time little productive work can occur. More importantly, it is rare for a replacement application to go into production without a problem, more commonly experiencing hundreds or thousands of problems, more than a sufficient number of which may overwhelm many operational environments. It may be very difficult or even impossible to shift back to the old system to get back to work again.

Modern application software development and testing methods focus on establishing the specifications for the development, consisting of the functional requirements plus the business rules that define how each such function is to operate. Since both the development and the testing are based on the same specifications, all testing is blind to defects in the specifications themselves. All phases of testing—unit testing, system testing, pre-production testing, etc.—share the same inherent defect: by being based on the same specifications, there is no standard of truth by which the validity of the testing can be established.

An older method of pre-production testing known as “production parallel testing” was based on using the old application system as the standard of truth instead of the specifications for the new application. This has fallen out of favor in preference to the “requirements based testing” method based on the specifications because of the logistical difficulty of performing production parallel testing for any period of time. In other words, the best method of controlling risk in modernization projects is no longer being used to do so because of practical difficulties. Thus, there remains a considerable need for devices and methods that can perform extended production parallel testing with minimal logistical difficulty. Minimizing the logistical difficulty rests on conveniently maintaining semantic equivalency between data elements common to the old and new persistent data stores.

### SUMMARY

Disclosed are a method, a device and/or a system of data synchronization between two data stores, one utilized by an application system designated AS1 and the other by an application system designated AS2.

Specifically, disclosed is a system that implements a continuous form of database synchronization during a period of extended production parallel operation and testing that can extend for months or years. This reduces the logistical difficulty of production parallel testing to sufficiently low levels to make production parallel testing practical. This also enables the incremental deployment of new functionality without disabling the old functionality, completely eliminating the “big bang” risk of operations being flooded with an overwhelming number of defects revealed suddenly when going into full production operation. Therefore, faced with any unforeseen problem, business operations can instantly drop back to the old system while problems are diagnosed and repaired. An integrated problem detection and diagnostic system continually monitors the old and new systems for functional equivalence, thereby discovering discrepancies missed in the sheer volume of data being processed. When such discrepancies are discovered, diagnostic reports are automatically produced to substantially accelerate debugging and problem resolution.

Disclosed is a method and system (hereinafter “Synchronizer”) for ensuring that the semantic content of a database connected solely to one application system (the master system, designated as AS1) is brought into equivalence with a database connected to another application system (the slave system, designated as AS2), and that equivalence can be maintained in real-time or near-real time. Alternatively, that equivalence can be re-established periodically in a batch execution mode, depending on the hardware and software configuration of the platforms used for AS1, for AS2 and for the Synchronizer.

In the case of an outage of any duration on either AS1 or AS2, the updates will accumulate until the other system is restored, at which time it will be brought back into synchronization prior to accepting any new transactions. The Synchronizer supports both uni-directional data level synchronization (AS1→AS2) and bi-directional functional synchronization (AS1→AS2 and AS1→AS2). The Synchronizer can be configured for either uni-directional data level synchronization, bi-directional functional synchronization, or both.

Either data level synchronization or functional synchronization may be used in a given configuration, or they may both be used, depending on the configuration. Data level synchronization is triggered when changes to one data store are initiated or detected, and are then propagated to the other, which occurs below the level of the program's business logic.

Since data level synchronization occurs below the level of the program's business logic, there is no opportunity to compare the results of execution of that logic. However, it is possible and useful to ensure that the common data elements have not lost their synchronization in the interim, which can occur under certain circumstances due to operational errors or to race conditions when duplicate update transactions from users are received by both AS1 and AS2 at almost the same time.

Functional synchronization occurs when a single update transaction or a set of transactions is received on one system, which triggers the Synchronizer's sending a corresponding transaction or set of transactions to the other. Since functional synchronization occurs above the level of the program's business logic, there is an opportunity to compare the results of execution of that logic.

Functional synchronization should provide the same result if the transactions in both systems have equivalent business rules, assuming that the data were synchronized at the outset. Conversely, if the results are not equivalent when the data were synchronized initially, then we can conclude that there is a discrepancy in the implementation of the business rules governing those transactions.

In one aspect, a method incorporating functional synchronization and data level synchronization to maintain semantic equivalence between at least two data stores first involves propagating, in real-time or at least near real-time, changes made to a first set of data elements stored in a first database to a second set of corresponding data elements stored in a second database. The first set of data elements and the second set of data elements comprise one or more overlapping data elements. The first database is associated with a first set of application system programs (AS1) and the second database is associated with a second set of application system programs (AS2). A functional synchronization event will occur only when there are one or more functionally equivalent transactions or sets of transactions in both AS1 and AS2. Data level synchronization will occur when there is a functionally equivalent transaction or set of transactions only in AS1. The method further involves comparing the first set of data elements and the second set of data elements for semantic equivalence after the functional synchronization event completes. The method also involves reporting any discrepancies between the first set of data elements and the second set of data elements in real-time including program diagnostics. Furthermore, the method involves validating propagated data elements against a data validation rule stack, and reporting any validation failures in real-time. Further yet, the method involves comparing the source data and the propagated data and reporting any out-of-synchronization errors in real-time.

In another aspect, a system incorporating functional synchronization and data level synchronization to maintain semantic equivalence between at least two data stores comprises a first database associated with a first set of application system programs (AS1) and a second database associated with a second set of application system programs (AS2). Semantic equivalence between the first database and the second database is achieved by propagating, in real-time or at least near real-time, changes made to a first set of data elements stored in the first database to a second set of corresponding data elements stored in the second database. The first set of data elements and the second set of data elements comprise one or more overlapping data elements. A functional synchronization event will occur only when there are one or more functionally equivalent transactions or sets of transactions in both AS1 and AS2. Data level synchronization will occur when there is a functionally equivalent transaction or set of transaction in only AS1. Furthermore, the system involves comparing the first set of data elements and the second set of data elements for semantic equivalence after the functional synchronization event completes. Also, the system involves reporting any discrepancies between the first set of data elements and the second set of data elements in real-time including program diagnostics. Further yet, the system involves validating propagated data elements against a data validation rule stack, and reporting any validation failures in real-time. Additionally, the system involves comparing the source data and the propagated data and reporting any out-of-synchronization errors in real-time.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a simplified overview of the Synchronizer system in operation, according to one or more embodiments.

FIG. 2 illustrates the data flow for data level synchronization from AS1 to AS2, according to one or more embodiments.

FIG. 3 illustrates the data flow for functional synchronization from AS1 to AS2, according to one or more embodiments.

FIG. 4 illustrates the data flow for functional synchronization from AS2 to AS1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of data synchronization.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Although the present embodiments have been described with reference to specific example embodiments, it will be evident that various modifications and changes may be made to these embodiments without departing from the broader spirit and scope of the various embodiments. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The description as follows is provided to enable any person skilled in the art to practice the various aspects and implement the various embodiments described herein. Various modifications to these aspects and embodiments will be readily apparent to those skilled in the art, and the generic principles defined herein may be applied to other aspects or embodiments. Thus, the claims are not intended to be limited to the embodiments shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

### 1.1 Description of the Related Art

### 1.1.1 Data Level Synchronization

Some database vendors as well as third party vendors provide data level synchronization, i.e., data synchronization triggered below the level of the program's business logic. Data level synchronization may also be implemented by programmers using trigger logic in the database itself, using a published API into the database, a facility implemented in the database definitions, an operator console feature, or an API discovered by reverse engineering of the operation of the database.

These facilities or products may or may not support the mapping of data from one data model to another, but any such mapping, if available tends to be limited. Some require that the data table definitions be identical.

Typically, data level synchronization is used over a long period of time to propagate updates from one operational database to another so that data queries can be directed against the target duplicate database rather than the operational database. This provides performance advantages for the operational database, which does not have to experience the internal processing delays that result from having simultaneous queries and updates affecting the same data. It also provides performance advantages as the operational database can be optimized for update performance and the target database can be optimized for query performance. The only drawback of this is that there is always a small latency between the update to the operational database and its replication being received.

Reliability issues have surfaced among these data level synchronization products because they usually do not use the database transactional capabilities to ensure that data consistency is maintained at all times.

During the course of migrating an application from an old data store to a new one, data level synchronization may be used for a short period of time during the migration. In general, due to the time required to unload a database and then load the data into a new database, it is necessary to take a snapshot of the database at a point in time, unload that snapshot, load the unloaded data into the target database, and then turn on data level synchronization to apply the changes to the source database that occurred subsequently to the snapshot being taken on to the target database. Once the target has been brought into equivalence with the source database, the processing may be switched to the new system with the new database and the data level synchronization stopped.

### 1.1.2 Functional Synchronization

Functional synchronization is a technique rather than a product which is occasionally used on a small scale to test the results of processing one application system against a known reference system.

Functional synchronization is most often used solely with online transaction processing programs, though with careful operational control it is possible to use the process with batch programs as well—provided that great care is taken in the computer operations to ensure that online and batch processing is single threaded through both systems in the same sequence.

Functional synchronization may be performed in real-time or near real-time, or the processing on one system may be recorded and presented to the other system at an operationally convenient time so that the equivalence can be re-established out of temporal simultaneity.

### 1.1.3 Coverage Analysis

The execution of a program under conditions that allow the recording of the logic paths that are actually executed within the program is typically called code coverage analysis, test coverage analysis, test code coverage analysis, or simply coverage analysis. Coverage analysis is a technique of long standing for aiding the process of testing software programs against both functional and non-functional requirements. By the nature of software testing, the requirements are known and it is the behavior or nature of the program which is being analyzed for conformance with those requirements.

All discussions of coverage analysis researched to date have related to this purpose of testing against known requirements, both functional and non-functional. The integrated coverage analysis facility in the Synchronizer records the logic path executed during each functional synchronization event, whether or not there is a discrepancy, but is reported only in case of a discrepancy. The summation of all logic paths executed across all functional synchronization transactions can be used to create a cumulative coverage report.

Each logical decision point in a program creates two logical pathways for subsequent execution, one in which the decision results in a true condition, and the other in which the decision results in a false condition. Coverage analysis, summed over the execution of one or more test cases, records the cumulative execution results for each decision point in a program, whether: the true logic path was executed, the false logic path was executed, both logic paths were executed, or neither logic path was executed.

The coverage analysis report may or may not report false logic path coverage if the false logic path is implicit in the program's source code rather than explicit, though it typically does not. The coverage report may or may not separately report true and false results from each component conditional statement of a compound conditional statement.

The scope of coverage reports is determined by the number of test cases used for a test execution of the program and the content of each test case. If only a single test case is used after resetting the counters used to record the execution of instructions, then only the logic associated with that one transaction will show as executed in the report. If more than one test case is executed at a time, or multiple executions without clearing the counters, then a cumulative coverage analysis report results showing the code executed by any of the test cases. If all test cases are executed then the resulting cumulative report that is produced may indicate omissions in the test cases, as indicated by logic paths not executed, and thereby determine additional test cases that may need to be created to meet coverage goals.

Testing against expected results is a “black box” test—do the inputs result in the expected outputs? Testers are typically not programmers, do not typically debug a program which fails to conform to requirements, and typically have no knowledge of the internals of a program. Although black box testers do not typically examine the internals of the program, they may create cumulative coverage analysis reports to determine whether or not their tests have reached some specific overall coverage percentage, typically 80% or 90%. In this regard, their interest may be only in the statistics from the report, not the executable statement content. Testers typically have no use for a coverage analysis report from a single transaction.

Coverage analysis is a “white box” process, in which the internal instructions of a program are revealed to those who will utilize the resulting reports, which show both those statements executed and those statements not executed. When utilized in conjunction with the Synchronizer integrated coverage analysis facility, it is this white box mode in which coverage analysis is used, particularly for the single transaction coverage analysis reports that result from a functional synchronization event.

In the Synchronizer, integrated coverage analysis is being used in a single execution mode showing only the coverage resulting from a single transaction. This is the opposite of its normal usage in black box testing which finds only cumulative code coverage to be useful. The single execution mode illustrates the logic executed and not executed during the transaction that resulted in a discrepancy, which allows rapid tracing of the source of the problems when used in a white box mode in conjunction with the Synchronizer.

### 1.2 Definition of the Invention

The invention (the “Synchronizer”) is a software device for ensuring that the semantic content of a database connected solely to one application system (designated as AS1) is brought into equivalence with a database connected to another application system (designated as AS2), and that equivalence is subsequently maintained in real-time or near-real time, or that equivalence can be re-established periodically in a batch execution mode, depending on the hardware and software configuration of the platforms used for AS1, for AS2 and for the Synchronizer.

### 1.3 Definitions

| Word or Phrase | Definition or Usage Herein |
|---|---|
| [noun](s) | Any reference to any noun X in the form of “X(s)” is defined |
| | to be read as meaning “one or more X's”. |
| “transaction” | is one element from a set of transient data. |
| “transaction(s)” | is defined as one or more transactions. |
| “transaction event” | is defined as the arrival of a transaction. |
| “pseudo-transaction” | is a sequence of program logic statements that results in a |
| | change of state in a database without the occurrence of a |
| | transaction event, the sequence being bounded by the |
| | execution of a database commit command. |
| “pseudo-transaction(s)” | is defined as one or more pseudo-transactions. |
| “query transaction(s)” | is defined as transaction(s) which when processed by |
| | program(s) will not change the state of the database. |
| “update transaction(s)” | is defined as transaction(s) which when processed by |
| | program(s) may change the state of the database. |
| “program” | as used herein is defined as referring to any complete set of |
| | executable computer commands which may be expressed in |
| | any form, and which may include (but is not limited to) any |
| | sub-programs, executable logic defined in a database of any |
| | kind, executable logic defined in a business rule management |
| | system, executable logic controlled by stored data, and/or |
| | any other executable component that can be controlled by the |
| | author or authors of the program. |
| “mainline program” | is a program which contains the entry point into the program |
| | required to initiate execution of the program by any |
| | component of the operating system of the computer. A |
| | “sub-program” is a program which is not initiated by any |
| | component of the operating system of the computer. |
| “program(s)” | is defined to mean either a single program or a set of |
| | programs. |
| “source code” of a | is the human readable set of computer commands which |
| program | define the executable logic of the program. |
| “object code” of a | is the set of computer commands which comprise the |
| program | executable logic of the program and which has been created |
| | by any means from the source code; it is typically but not |
| | always in a non-human readable form. |

Any given program can be categorized as follows whether executed interactively or in
batch:

| | |
|---|---|
| “query program” | is defined as a program whose execution will not change the |
| | state of the database. |
| “update program” | is defined as a program whose execution may change the |
| | state of the database. Update programs are defined as falling |
| | into one of three sub-categories: |
| “periodic batch” | is defined as an update program whose execution may |
| program | change the state of the database without the input of any |
| | transient data. |
| “transactional batch” | is defined as an update program whose execution may |
| program | change the state of the database using batch transaction(s). |
| “interactive” program | is defined as an update program whose execution may |
| | change the state of the database using interactive |
| | transaction(s). |
| “database” | is defined as the complete set of persistent data that can be |
| | queried and/or updated by program(s) including one or more |
| | instances of one or more database management systems |
| | and/or indexed data files and/or randomly accessed data files |
| | and/or sequential data files and/or any other relevant data |
| | stores. |
| “transient data” | is defined as any data which is not persisted to permanent |
| | storage in a database and may include messages and/or |
| | records from data files which will be processed by |
| | program(s) in order to change the state of a database or to |
| | query data from a database. |
| “production database” | is a database which contains the data used to fulfill the |
| | operational purpose of the program(s). |
| “test” | is the process of exercising the executable logic of |
| | program(s) to determine whether the behavior of the |
| | program(s) produces the results that are expected. |
| “test database” | is a database which contains the data used to test program(s), |
| | but which is not used to fulfill the operational purpose of the |
| | program(s). A production database may be used as a test |
| | database if the updated database is not used to fulfill the |
| | operational purpose of the program(s). |
| “baseline database” | is a test database which has been validated to demonstrate |
| | that it can be repeatedly reloaded and a consistent set of |
| | programs executed in an identical manner to give the |
| | identical results each time. |
| “interactive | refers solely to transaction(s) received as message(s) |
| transaction(s)” | |
| “batch transaction(s)” | refers solely to record(s) from a file of transaction(s). |
| “periodic batch test | is a test database in a specific state such that when processed |
| case” | by periodic batch program(s) will produce an expected |
| | result. |
| “transactional test | is a test database in a specific state plus transient data such |
| case” | that when the transient data is processed by transactional |
| | batch program(s) or interactive program(s) will produce an |
| | expected result. |
| “test case” | either a periodic batch test case or a transactional test case. |
| “atomic test case” | is a test case prepared such that it represents the smallest |
| | possible execution, typically a single transaction for a |
| | transactional test case and the smallest change in the state of |
| | the database which is practical for a periodic batch test case. |
| “cumulative test cases” | the summation of all atomic test cases, i.e., the initial set of |
| | test cases as augmented over time with additional atomic test |
| | cases. |
| “test data” | a test database and one or more periodic batch test cases |
| | and/or one or more transactional test cases. |
| “all test data | the collection of the baseline test database, all test cases, and |
| | the test database backup after execution of all test cases. |
| “test data team” | is defined as an individual or team separate from the |
| | business rule analyst which is authorized to create test data. |
| “instrumentation” | the process by which program(s) have new source code |
| | records inserted into their source codes and/or have existing |
| | source code records modified and/or have existing source |
| | code records deleted according to pre-programmed rules. |
| | “Instrument” is the transitive verb form of instrumentation. |
| “instrumented logic” | consists of the new source records inserted and/or the |
| | existing source records modified and/or the existing source |
| | records deleted during the process of instrumentation. |
| “instrumentation rules” | consist of the pre-programmed rules which control the |
| | source code insertion and/or modification and/or deletion. |
| “coverage analysis” | “coverage analysis”, “code coverage”, “code coverage |
| | analysis”, “test code coverage”, “test code coverage |
| | analysis” and other variations should be understood to refer |
| | to precisely the same process, that there is no meaningful |
| | distinction among them, and that they can be used |
| | interchangeably without ambiguity. |
| “coverage analysis | the process by which the coverage analysis module of the |
| instrumentation” | invention will instrument the program(s) with functionally |
| | neutral, diagnostic logic that records the logic pathways |
| | within the program that are actually executed by the test data |
| | presented to the program at execution time. |
| | Optionally, the instrumented logic inserted by the coverage |
| | analysis module of the invention ensures the recording of |
| | both the true logic path and the false logic path whether or |
| | not there is an explicit “ELSE” condition contained within |
| | the program source code for the logical test in question. |
| | Optionally, the instrumented logic inserted by the coverage |
| | analysis module of the coverage analysis module of the |
| | invention records whether or not each element of a |
| | compound conditional expression has been tested. |
| Data level | Data synchronization implemented by the propagation of |
| synchronization | database changes below the level of the business logic of the |
| | programs creating the changes. |
| Functional | Data synchronization implemented by the routing of |
| synchronization | semantically equivalent transactions or sets of transactions to |
| | two different systems. The updates to the persistent data |
| | store must pass through the business rule logic in the |
| | transactions. |
| “reference | is defined as the minimal reproduction of the existing |
| implementation” | business rule functionality only, usually in the language and |
| | execution environment desired for the replacement |
| | application. A reference implementation needs only the |
| | update transactions reproduced for validation purposes. |
| | Query transactions, reports, analytics, a user interface and |
| | other non-essentials are not required. If planned properly, the |
| | reference implementation can form the nucleus of a new |
| | implementation. |
| “event” | The initiation of a process that may or may not result in a |
| | change of state within a database. |
| “single message” | is defined as one message received from a communications |
| | process, one entry read from a sequential file, one row |
| | selected from a database data table, the initialization of one |
| | program memory area with the identity and parametric |
| | information from a pseudo-transaction, or any other |
| | equivalent mechanism is initiated by which a single process |
| | may lead to a change of state in the database. |
| “messages” | is defined as one or more single messages |
| “before image” | is defined as the values of the relevant columns in a single |
| | row from a data table prior to that row being updated in a |
| | database transaction. |
| “after image” | is defined as the values of the relevant columns in a single |
| | row from a data table after that row was updated in a |
| | database transaction. |
| “unit of work” | is defined as the set of information that contains all |
| | information relating to an event that is required by the |
| | Synchronizer to accomplish data level and functional |
| | synchronization, which includes at least the following |
| | information from each member in the set as a sequential |
| | entry in a reserved data table in the same database and which |
| | is coordinated within the scope of the same database |
| | transaction as the data updates being recorded to data rows |
| | other than that of the reserved data table: |
| | A single entry which defines the beginning of a unit |
| | of work must be the first entry in the set (the “unit of |
| | work header record”) |
| | One or more pairs of contiguous entries, one for |
| | each data change within the database: |
| | The before image of the relevant columns from a |
| | single row in a data table or a null entry if the |
| | data is being inserted into the database |
| | The after image of the relevant columns from a |
| | single row in a data table or a null entry if the |
| | data is being deleted from the database |
| | Zero or more informational records, which includes |
| | but is not limited to the logic path information that |
| | can be used to create a single transaction code |
| | coverage report or a cumulative code coverage |
| | report |
| | A terminator record which defines the end of the unit |
| | of work |
| Mirror tables | The data tables that result from a minimally renormalized |
| | data model from AS1 are referred to as the mirror tables. If |
| | the data model from AS1 is already relational, then AS1 will |
| | be identical in its structure with the mirror tables. If the |
| | AS1 database is not relational, then the minimum required |
| | require to successfully load the data into the mirror tables |
| | will define the mirror tables. |
| Synchronizer tables | The Synchronizer tables are used to manage the execution |
| | and recovery of the Synchronizer. They will contain the |
| | single message from the unit of work header record plus |
| | configuration and status information used to control the |
| | execution and recovery of the Synchronizer. |
| Optimistic locking | The execution of insert, update or delete SQL commands |
| | with a WHERE condition such that the current contents of |
| | the row undergoing a change will first be compared against |
| | the old values from the before record. The Synchronizer |
| | utilizes optimistic locking to ensure that data |
| | synchronization has been previously lost prior to the data |
| | being synchronized with the updated values. |

### 1.4 Data Synchronization Process for Asynchronous Operation

Note that functional synchronization is always asynchronous. However, data level synchronization may be asynchronous, or it may be synchronous by virtue of a database configuration that permits either a single phase commit or a two phase commit when updating any of the databases. The embodiment described below comprises of asynchronous data level synchronization.

In an asynchronous configuration, maintaining data integrity requires that one system be designated as the master, in this case AS1 is defined as the master, and the other, AS2 in this case, is defined as the slave. This means that all functional synchronization transactions are processed on AS1 first, whether or not they originate by input to AS1 or to AS2, and only if successfully processed will the transaction reach AS2. Uni-directional data level synchronization is always master to slave.

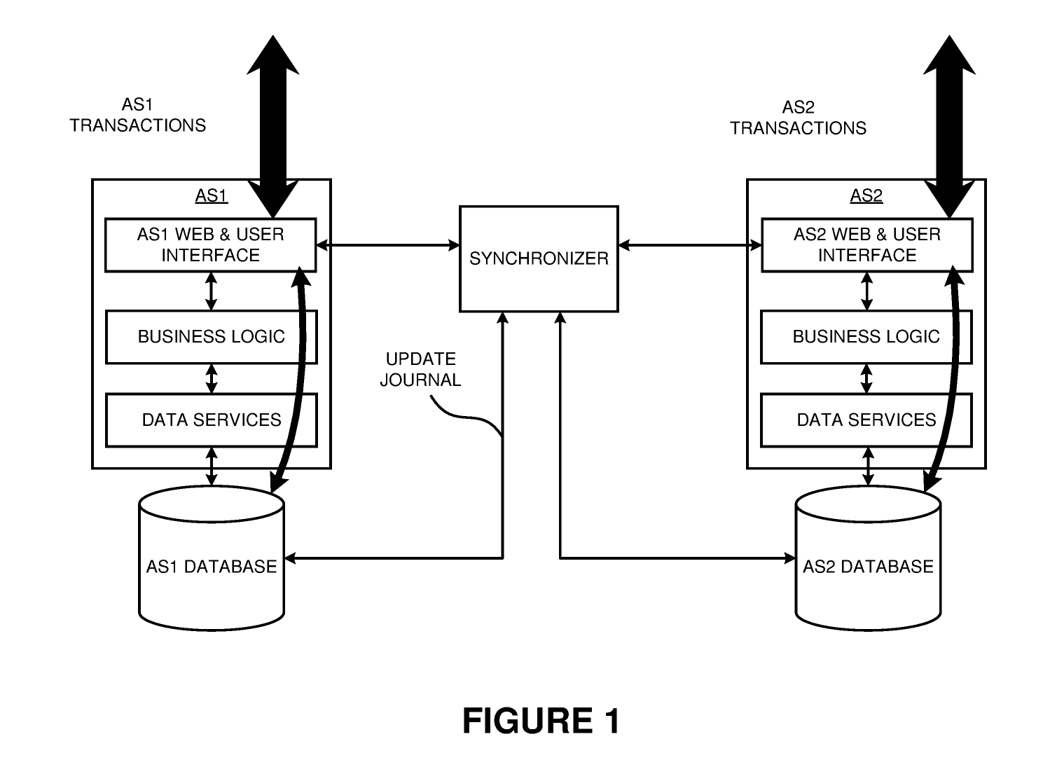

Reference is now made to FIG. 1, which is an overview of the components of the Synchronizer system and their points of interaction during operation, according to one or more embodiments, with arrows indicating the flow of transactions into and out of Application System 1 (AS1) and into and out of Application System 2 (AS2). The system also comprises the Synchronizer module, which operates between AS1 and AS2 and has direct connections to both an AS1 database and an AS2 database and messaging connections to a web and user interface layer of each of AS1 and AS2.

The data model of the database for AS1 may or may not be identical to the data model of the database for AS2, even if both are relational. In order to provide mapping from one data model to another, the Synchronizer itself has a data model which consists of the mirror tables plus Synchronizer tables (not shown in the Figures). An event on AS1 results in the creation of a unit of work in the Update Journal and sending of an alert message to the Synchronizer. An event on AS2 does not result in the creation of a unit of work.

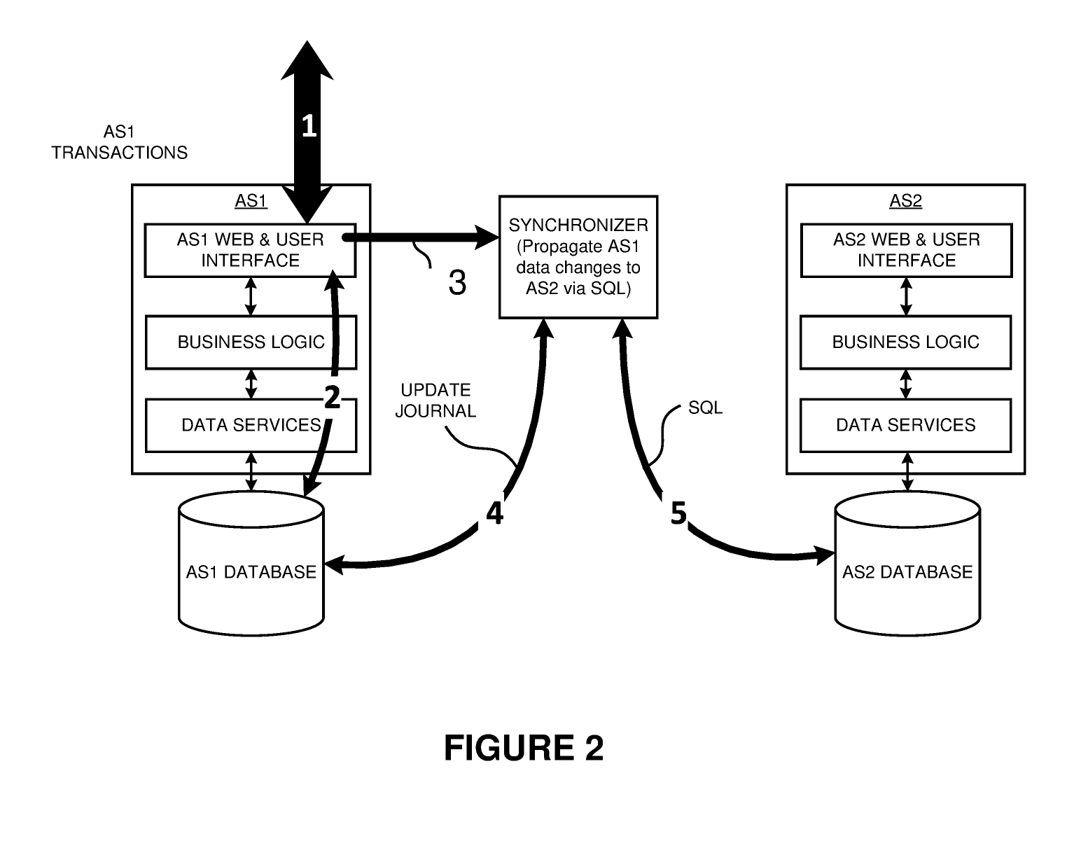

Reference is now made to FIG. 2, which illustrates the flow of messages and data in the case of an event on AS1 which results in data level synchronization from AS1 to AS2, according to one or more embodiments. Arrow 1 represents the path of the arriving message which passes into and eventually back out of the web and user interface. Arrow 2 represents the path through the AS1 software stack and results in an update to the AS1 database and a response back to the web and user interface, and thence to the originating user. Arrow 3 represents the alert message sent to the Synchronizer indicating a unit of work recently added to the Update Journal. Arrow 4 represents the path of the unit of work created by this event which is processed by the Synchronizer, resulting in an equivalent update to the AS2 database via a direct SQL connection represented by Arrow 5.

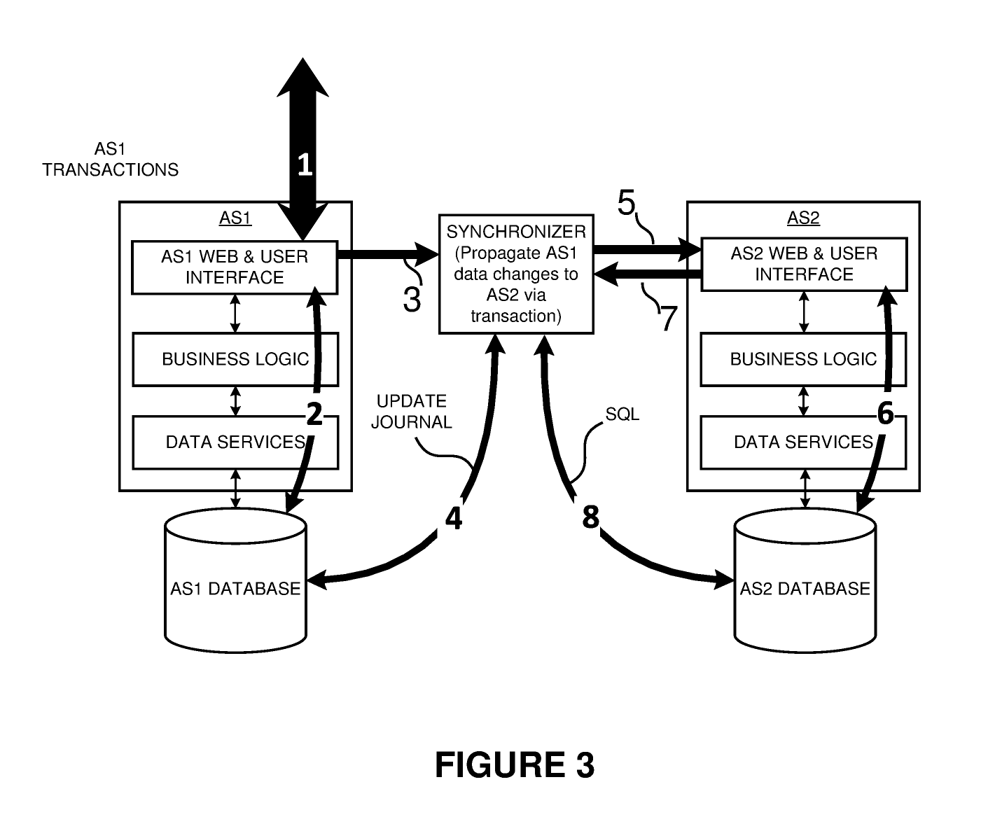

Reference is now made to FIG. 3, which represents the flow of messages and data in the case of an event on AS1 which results in functional synchronization to AS2, according to one or more embodiments. Arrow 1 represents the path of the arriving message which passes into and eventually back out of the web and user interface. Arrow 2 represents the path through the AS1 software stack and results in an update to the AS1 database and a response back to the web and user interface, and thence to the originating user. Arrow 3 represents the alert message sent to the Synchronizer indicating a unit of work recently added to the Update Journal. Arrow 4 represents the path of the unit of work created by this event which is processed by the Synchronizer, resulting in an equivalent message being sent to the AS2 web and user interface as indicated by Arrow 5. Arrow 6 represents the processing through the AS2 software stack and updates to the AS2 database. Arrow 7 represents the notice to the Synchronizer that the synchronizing transaction has completed successfully so that it may compare the results of processing on AS1 versus AS2, the AS2 SQL connection represented by Arrow 8. The comparison is made against the mirror tables (not shown) instead of against the AS1 database directly both for performance reasons and, more importantly, because the mirror tables accurately represent the state of the AS1 database at the point in time that the unit of work was created.

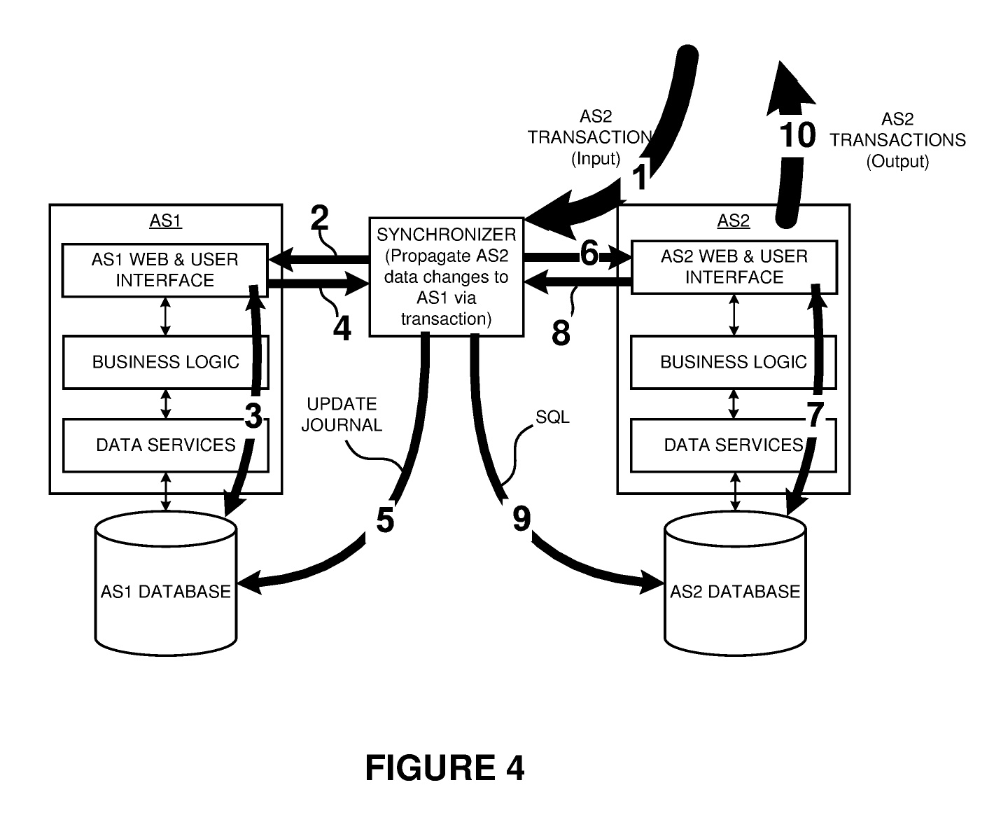

Reference is now made to FIG. 4, which represents the flow of messages and data in the case of an event on AS2 which results in functional synchronization to AS1, according to one or more embodiments. Arrow 1 represents the path of the arriving message for AS2 which is redirected to the Synchronizer for processing. The message is reformatted and sent to AS1 as indicated by Arrow 2, as a result of the principle that processing always occurs on the master before on the slave. Arrow 3 represents the message as it passes through the AS1 software stack and results in an update to the AS1 database and a response back to the web and user interface. Arrow 4 represents the alert message to the Synchronizer to process the unit of work recently added to the Update Journal by this event. Arrow 5 represents the path of the unit of work created by this event which is processed by the Synchronizer, resulting in the release of the original input to AS2 into the AS2 web and user interface as indicated by Arrow 6. Arrow 7 represents the processing through the AS2 software stack and updates to the AS2 database. Arrow 8 represents the notice to the Synchronizer that the synchronizing transaction has completed successfully so that it may compare the results of processing on AS1 versus AS2 via the AS2 SQL connection represented by Arrow 9. The comparison is made against the mirror tables (not shown) instead of against the AS1 database directly both for performance reasons and, more importantly, because the mirror tables accurately represent the state of the AS1 database at the point in time that the unit of work was created. Arrow 10 represents the response message returned to the originating user.

The preceding figures represent the flow from the point of view of the message and data flows associated with each single message input. From the point of view of the Synchronizer, the data synchronization process in the Synchronizer is driven by the detection of an event, which can take one of 4 forms:
a) The arrival of a message from AS1, which can indicate one of two conditions:
   i. A single message has arrived into AS1 and been processed successfully; (no notification is given of unsuccessfully processed single messages originating into AS1 and so this unsuccessful condition will never occur at the Synchronizer). This condition causes the Synchronizer to immediately check for the presence of an unprocessed unit of work in the reserved data table in the AS1 database. This can occur either for AS1 to AS2 data level synchronization (FIG. 2) or for AS1 to AS2 functional synchronization (FIG. 3.)
   ii. A single message has arrived into AS1 passed from AS2 by the synchronizer, (FIG. 4 arrows 1, 2 and 3), which had one of two results:
      1) Valid result from processing on AS1 causes the Synchronizer to immediately check for the presence of an unprocessed unit of work in the reserved data table in the AS1 database (the “Update Journal”) represented by FIG. 4 Arrow 5, and to proceed to update the mirror tables as described in paragraph [0105] but to halt after doing so, without invoking the data level synchronization process. The Synchronizer will notify AS2 (FIG. 4 arrow 6) to proceed with the processing of the input message held in suspension until the results of processing on AS1 were known.
      2) Invalid result from processing on AS1 causes the Synchronizer to notify AS2 (FIG. 4 arrow 6) that the input transaction failed on AS1 and therefore it was to reject the message. FIG. 4 arrows 7, 8 and 9 do not occur in this case, and arrow 10 represents the error message returned to the originating user.
b) The arrival of an input message from AS2, which can be one of two conditions:
   i. A single message which does not correspond to any message currently in flight is added to the list of messages in flight and submitted to AS1 as if arriving from a normal workstation, (FIG. 4 arrows 1 and 2).
   ii. A single message which does correspond to a message currently in flight indicates the completion of processing on AS2 (FIG. 4 arrow 8) in which case the entries in the control tables for that message are purged; the result of processing on AS2 can be either:
      1) Processing on AS2 was not successful, and the Synchronizer notifies the operator that the related set of data is out of synchronization in order to take corrective action.
      2) Processing on AS2 was successful, in which case the Synchronizer proceeds to compare the results of processing between the two systems for equivalence (FIG. 4, arrow 9) and to return the response message to the originating user (FIG. 4, arrow 10). The results of the comparison can be either:
         (1) If the processing results are equivalent, then the processing of this single message is complete.
         (2) If the processing results are not equivalent, then the Synchronizer notifies the operator that the related set of data is out of sync in order to take corrective action, and that the processing of this single message is complete.
c) The arrival of an input message from the operator's control workstation; the Synchronizer processes the input request and returns to its wait condition.
d) Expiration of a timer interval, which causes the Synchronizer to immediately check for the presence of an unprocessed unit of work in the reserved data table in the AS1 database; one should only be present as a result of a race condition between the arrival of the alert and the timer expiration, but this redundancy serves to ensure that, in the very rare case of the alert message never arriving, the unit of work will be processed in a reasonably timely manner.

In case [0104](a) or if an unprocessed unit of work is discovered in case [0104](d), the after images are applied to the mirror tables and the single message from the unit of work header record will be inserted into the Synchronizer tables. Then the next steps depend on whether this particular single message type is configured for functional synchronization, in which case functional synchronization occurs, or not, in which case data level synchronization occurs.
a) Data level synchronization case:
   i. The before data and the after data are all loaded into respective sets of memory buffers.
   ii. In addition, any linked information from the mirror tables that will be required to perform data validation will also be loaded into memory buffers.
   iii. Then data mapping from the AS1 data model to the AS2 data model will be performed in their respective sets of data buffers for both the before data and the after data.
   iv. Then data validation is performed against the data in the AS2 data model, with any data validation failures reported. Synchronization may continue irrespective of the results of data validation based on configuration options.
   v. The data from the AS2 buffers will then be updated into the AS2 data tables, using the before images to ensure that the data table rows remain synchronized by virtue of using the optimistic locking construct, while the INSERT, UPDATE or DELETE SQL statement actually propagates the data changes to the AS2 data tables by referencing the after data.
b) Functional synchronization case: In case of functional synchronization, the message is passed to the AS2 application, with Synchronizer data tables updated to cater for the fact that a functional synchronization message has been released to the AS2.

When case [0104](d) occurs without detecting a unit of work to process, the Synchronizer returns to its timer to wait for another event.

What is claimed is:

1) A method incorporating functional synchronization and data level synchronization to maintain semantic equivalence between at least two data stores comprising:
propagating, in real-time or at least near real-time, changes made to a first set of data elements stored in a first database to a second set of corresponding data elements stored in a second database,
wherein the first set of data elements and the second set of data elements comprise one or more overlapping data elements,
wherein the first database is associated with a first set of application system programs (AS1) and the second database is associated with a second set of application system programs (AS2),
wherein a functional synchronization event will occur only when there are one or more functionally equivalent transactions or sets of transactions in both AS1 and AS2,
wherein data level synchronization will occur when there is no functionally equivalent transaction or set of transactions in AS2 to correspond with a given transaction or set of transactions in AS1;
comparing the first set of data elements and the second set of data elements for semantic equivalence after the functional synchronization event completes;
reporting any discrepancies between the first set of data elements and the second set of data elements in real-time including program diagnostics,
validating propagated data elements against a data validation rule stack, and reporting any validation failures in real-time;
comparing the source data and the propagated data and reporting any out-of-synchronization errors in real-time.

2) The method of claim 1, comprising:
providing comprehensive automated testing of an existing application against a proposed replacement application by utilizing bi-directional functional synchronization and data comparisons following each functional synchronization event.

3) The method of claim 1 which, when applied to modernization of a legacy application, allows for incremental deployment of one or more new, production-ready components of a replacement system while additional components are being developed and tested, allows for usage of either the legacy application or new application transactions or batch programs as desired, and allows for an instantaneous fallback to the old components of the legacy application if a significant problem is detected in the operation of the new, production-ready components.

4) A system incorporating functional synchronization and data level synchronization to maintain semantic equivalence between at least two data stores, comprising:
a first database associated with a first set of application system programs (AS1);
a second database associated with a second set of application system programs (AS2),
wherein semantic equivalence between the first database and the second database is achieved by:
propagating, in real-time or at least near real-time, changes made to a first set of data elements stored in the first database to a second set of corresponding data elements stored in the second database,
wherein the first set of data elements and the second set of data elements comprise one or more overlapping data elements,
wherein a functional synchronization event will occur only when there are one or more functionally equivalent transactions or sets of transactions in both AS1 and AS2,
wherein data level synchronization will occur when there is no functionally equivalent transaction or set of transactions in AS2 to correspond with a given transaction or set of transactions in AS1;
comparing the first set of data elements and the second set of data elements for semantic equivalence after the functional synchronization event completes;
reporting any discrepancies between the first set of data elements and the second set of data elements in real-time including program diagnostics;
validating propagated data elements against a data validation rule stack, and reporting any validation failures in real-time;
comparing the source data and the propagated data and reporting any out-of-synchronization errors in real-time.

5) The system of claim 4, wherein maintaining semantic equivalence further comprises:
providing comprehensive automated testing of an existing application against a proposed replacement application by utilizing bi-directional functional synchronization and data comparisons following each functional synchronization event.

6) The system of claim 6 which, when applied to modernization of a legacy application, allows for incremental deployment of one or more new, production-ready components of a replacement system while additional components are being developed and tested, allows for usage of either the legacy application or new application transactions or batch programs as desired, and allows for an instantaneous fallback to the old components of the legacy application if a significant problem is detected in the operation of the new, production-ready components.
